(19) United States
(12) Patent Application Publication
(10) Pub. No.: US 2024/0145773 A1
(43) Pub. Date: May 2, 2024

(54) COMPOSITE SOLID-STATE ELECTROLYTE, PREPARATION METHOD THEREOF AND ALL-SOLID-STATE LITHIUM METAL BATTERY

(71) Applicant: The Hong Kong University of Science and Technology, Hong Kong (CN)

(72) Inventors: Yoonseob KIM, Hong Kong (CN); Jun HUANG, Hong Kong (CN); Chen LI, Hong Kong (CN); Gitaek BANG, Hong Kong (CN)

(21) Appl. No.: 18/485,386

(22) Filed: Oct. 12, 2023

Related U.S. Application Data
(60) Provisional application No. 63/379,145, filed on Oct. 12, 2022.

(51) Int. Cl. H01M 10/0565; H01M 10/0525; H01M 10/0568; H01M 10/0569

(52) U.S. Cl. CPC H01M 10/0565; H01M 10/0525; H01M 10/0568; H01M 10/0569

(57) ABSTRACT

A composite solid-state electrolyte, a preparation method thereof and an all-solid-state lithium metal battery. The composite solid-state electrolyte includes a cationic poly(ionic liquid) as a matrix; and an ionic covalent organic framework, TpPa—SO3Li, as a filler. The method for preparing a composite solid-state electrolyte includes combining the poly(ionic liquid) with the ionic covalent organic framework to prepare the composite solid-state electrolyte. The composite solid-state electrolyte can have excellent ionic conductivity up to 1.23×10⁻³ Scm⁻¹ and Li ion transport number (t_{Li}_{⁺}) up to 0.82 at room temperature. The composite solid-state electrolyte and the all-solid-state lithium metal battery containing the composite solid-state electrolyte provided by the present invention can achieve long-term safety while achieving high performance, and show great potential in the practical application of all-solid-state lithium metal batteries with high security.

### CROSS-REFERENCE TO RELATED APPLICATIONS

The present application claims priority from U.S. Provisional Patent Application No. 63/379,145, filed on Oct. 12, 2022, which is hereby incorporated by reference in its entirety.

### TECHNICAL FIELD

The present disclosure relates to the field of batteries, in particular to a composite solid-state electrolyte comprising an ionic covalent organic framework and poly (ionic liquid) and a preparation method of such composite solid-state electrolyte and an all-solid-state lithium metal battery comprising the same.

### BACKGROUND

Developing next-generation lithium battery systems with high energy density and improved safety is critical for energy storage sectors such as electric vehicles, portable electronics and the grid energy industry. All-solid-state lithium metal battery (ASSLMB) is a promising battery candidate. Replacing flammable organic solvent electrolytes with solid-state electrolytes not only improves safety, but also enables high energy density using metallic lithium as the cathode material^{[}2]. As key components, solid-state electrolytes (SSE) such as polymers, oxides, and sulfides have been intensively studied to meet the requirements of high-performance ASSLMBs. Improving the ionic conductivity of solid-state electrolytes is crucial for high-performance ASSLMBs.

Among solid-state electrolytes, oxide solid-state electrolytes have poor chemical and electrochemical stability although they have high ionic conductivity. For example, garnet-type oxides have high electrical conductivity exceeding 10⁻³ Scm⁻¹ at room temperature (r.t.) but are unstable in air^{[6]}. Sulfide solid-state electrolytes have the highest ionic conductivity but are limited by their high cost and low stability to lithium and air. In particular, Li₁₀GeP₂S₁₂ ceramics have high conductivity over 10⁻² Scm⁻¹; but Ge is expensive, and this electrolyte is poorly mass-produced.

Covalent organic framework (COF) is a crystalline and porous polymer material having highly stable covalent bonds formed by reversible reactions of organic connecting parts such as nodes and chains, and was first synthesized in 2005. As a unique type of COF, ionic covalent organic framework (iCOF) was first reported in 2016^{[9]}. Because of its clear nanochannels^{[13-15]}, COF shows great potential in ion transport^{[10-12]} and can especially be used as a solid-state electrolyte (SSE) material for lithium metal batteries.

Sang-YoungLee et al. demonstrated a solvent-free and single-ion conductive lithium sulfonated COF SSE with a low conductivity of 2.7×10⁻⁵ Scm⁻¹ at room temperature. KingPingLoh et al. developed a solution-processable COF SSE with a conductivity of 3.21×10⁻⁵ Scm⁻¹ at 20° C. To this end, FanZhang et al. added polyethylene (PEO) to iCOF and prepared a vinyl-linked iCOF composite SSE with Li⁺ conductivity at 20° C. increased to 4.17×10⁻⁴ Scm⁻¹, but its Li⁺ conductivity is not ideal in practical applications, and the transport number is still low (FIG. 1b).

If plasticizers such as polycarbonate are introduced into iCOF SSE, ultrahigh ionic conductivity can be achieved. For example, after adding polycarbonate plasticizer, the ionic conductivity of CF³⁻Li⁻ImCOF reaches the highest value of 7.2×10⁻³ Scm⁻¹ for COF-type SSE at 25° C. However, adding organic solvent plasticizers can bring potential safety issues to batteries because most organic solvents are flammable. The ideal ASSLMB solid-state electrolyte should be solvent-free to ensure safety for long-term use. However, it is still challenging to achieve high conductivities of solid-state electrolytes exceeding 10⁻³ Scm⁻¹ at room temperature without using plasticizers or at the cost of safety.

### SUMMARY

An objective of the present disclosure is to provide a composite solid-state electrolyte (SSE). The composite SSE provided by the present disclsoure preferably has excellent ionic conductivity under room temperature conditions and exhibits a high lithium ion transport number (t_{Li}_{⁺}).

In a first aspect, provided herein is acomposite solid-state electrolyte, comprising: a cationic poly(ionic liquid); and an ionic covalent organic framework (TpPa—SO₃Li) comprising a repeating unit of Formula I:

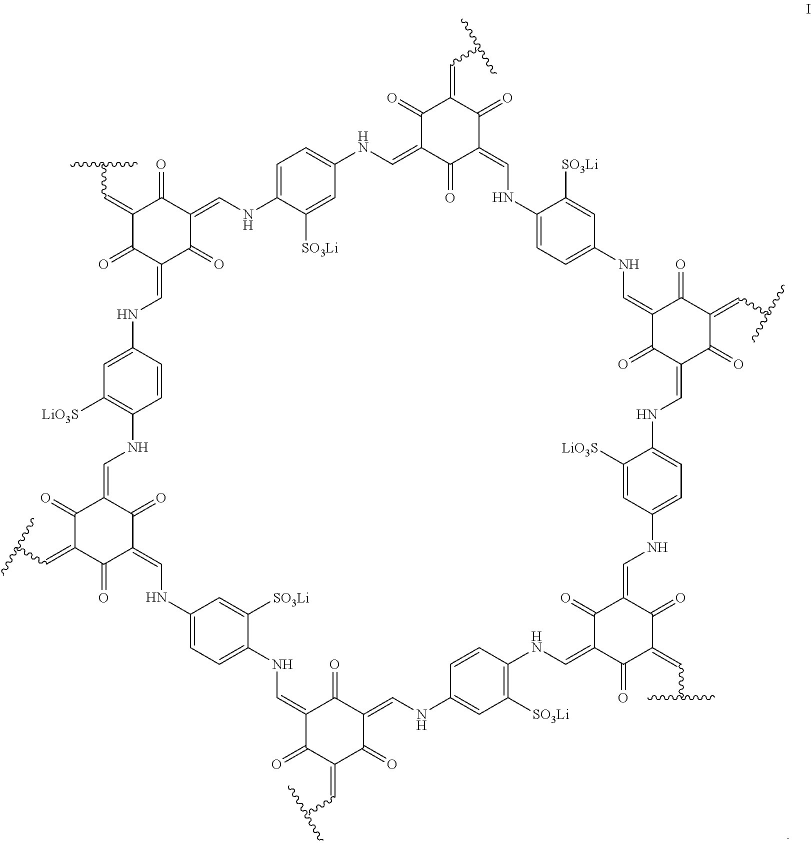

In certain embodiments, the cationic poly(ionic liquid) comprises a repeating unit of Formula II:

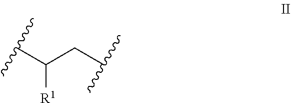

wherein R¹ is selected from the group consisting of:

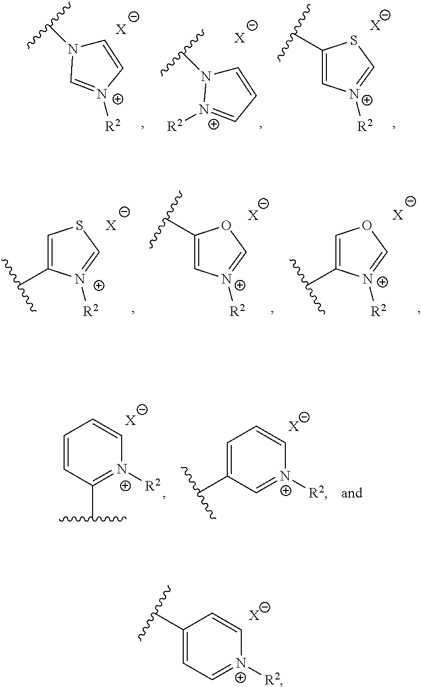

wherein R² is C₁-C₆ alkyl; and X⁻ is an anion.

In certain embodiments, R¹ is:

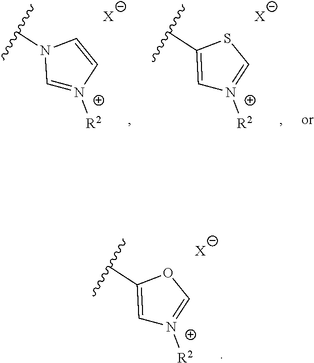

In certain embodiments, the cationic poly(ionic liquid) comprises a poly(1-(C₃-C₅alkyl)-3-vinylimidazolylium) salt.

In certain embodiments, the cationic poly(ionic liquid) comprises a poly(1-butyl-3-vinylimidazolylium) salt.

In certain embodiments, the cationic poly(ionic liquid) is poly(1-butyl-3-vinylimidazolylium) bis(trifluoromethanesulfonyl)imide salt.

In certain embodiments, the poly(1-butyl-3-vinylimidazolylium) bis(trifluoromethanesulfonyl)imide salt is combined with a lithium salt from an external source.

In certain embodiments, TpPa—SO₃Li is prepared according to a method comprising combining 2,5-diaminobenzenesulfonate with 2,4,6-trihydroxybenzene-1,3,5-tricarbaldehyde thereby forming TpPa—SO₃Li.

In certain embodiments, TpPa—SO₃Li accounts for 10-50 wt % of the total weight of the composite solid-state electrolyte.

In certain embodiments, the TpPa—SO₃Li accounts for 10-15.6 wt % of the total weight of the composite solid-state electrolyte.

In certain embodiments, the cationic poly(ionic liquid) is poly(1-butyl-3-vinylimidazolylium) bis(trifluoromethanesulfonyl)imide salt and TpPa—SO₃Li and poly(1-butyl-3-vinylimidazolylium) bis(trifluoromethanesulfonyl)imide salt are present in a mass ratio of 95:5 to 1:1, respectively.

In certain embodiments, the composite solid-state electrolyte does not comprise an organic solvent or a plasticizer.

In a second aspect, provided hereini s an all-solid-state lithium metal battery, comprising the composite solid-state electrolyte described herein.

In certain embodiments, the all-solid-state lithium metal battery is selected from a symmetric button battery, a full button battery and a pouch battery.

In certain embodiments, the all-solid-state lithium metal battery is a lithium|composite solid-state electrolyte|lithium symmetric button battery or a lithium|composite solid-state electrolyte|lithium cobalt oxide full button battery.

In a third aspect, provided herein is a method for preparing the composite solid-state electrolyte described herein, comprising combining the cationic poly(ionic liquid) and TpPa—SO₃ Li thereby forming the composite solid-state electrolyte.

The present disclosure further provides a method for preparing the above composite solid-state electrolyte, and the method can adopt a simple process flow to prepare the composite solid-state electrolyte in a low-cost and environmentally friendly manner.

The present disclosure further provides a high-performance all-solid-state metal lithium battery (ASSLMB) containing the above-mentioned composite solid-state electrolyte. This all-solid-state metal lithium battery has a wide electrochemical window, high specific capacity and high cycle stability.

The present disclosure also provides a use of poly(ionic liquid) (PIL) as a matrix and iCOF as a filler to prepare SSE, in order to improve the conductivity of SSE. In certain embodiments, a composite SSE based on TpPa—SO₃Li is prepared by combining the ionic covalent organic framework TpPa—SO₃Li with imidazole-based polymer p(BVIm-TFSI) coordinated by TFSI. The highest ionic conductivity of the SSE at room temperature can exceed 10⁻³ Scm⁻¹.

The above technical solutions of the present disclosure have at least the following advantages:
The composite solid-state electrolyte (SSE) of the present disclosure has excellent lithium ion conductivity, especially at room temperature, which can exceed 10⁻³ Scm⁻¹ at most. In addition, although the solid-state electrolyte of the present disclosure does not have single-ion conductivity, it can still exhibit a lithium ion transport number of up to 0.82 t_{Li}_{⁺}.
   The reason why the composite SSE of the present disclosure can achieve rapid lithium ion conduction is that, on one hand, the gaps between iCOFs (such as TpPa—SO₃Li) are filled with poly(ionic liquid), which results in the composite SSE having lower contact resistance; on the other hand, it benefits from the co-ordination structure between Li⁺ and poly(ionic liquid) in this composite SSE system, such as in the case of TpPa—SO₃Li-p(BVIm-TFSI) SSE, the co-coordination structure generated between Li⁺, TFSI⁻ and the polycations of the BVIm polymer chain.
The composite solid-state electrolyte of the present disclosure and the all-solid-state lithium metal battery containing the composite solid-state electrolyte may not contain organic solvents and/or plasticizers, so it is possible to avoid potential safety issues caused by adding organic solvents and/or plasticizers. That is to say, the composite solid-state electrolyte and the all-solid-state lithium metal battery containing the composite solid-state electrolyte provided by the present disclosure can achieve long-term safety while achieving high performance. As the present disclosure has demonstrated, the composite SSE of the present disclosure is efficient and stable when used to assemble “lithium|SSE|lithium” symmetric button batteries and “lithium|SSE|lithium cobalt oxide” full button batteries. This method for manufacturing high performance SSE shows great potential in practical applications of high-security ASSLMB.
The method for preparing the above-mentioned composite solid-state electrolyte provided by the present disclosure can adopt a simple process flow to prepare the above-mentioned composite solid-state electrolyte in a low-cost and environmentally friendly manner, which provides huge potential for the large-scale production of the composite solid-state electrolyte product of the present disclosure. In particular, compared with sulfide solid-state electrolytes in the prior art, such as Li₁₀GeP₂Si₂, the composite SSE provided by the present disclosure and the preparation method thereof can significantly reduce production costs by avoiding the use of expensive Ge, which is conducive to the expanded production of electrolyte products.

### BRIEF DESCRIPTION OF THE DRAWINGS

The form of this process will now be described by way of example with reference to the accompanying drawing, in which:

FIG. 1 is a schematic diagram illustrating the comparison of ion transport in the composite solid-state electrolyte provided by the prior art (a and b) and the present disclosure (c), in which a. shows the structure of pure iCOF, showing a larger void volume; (b) shows a polymer-containing iCOF composite material (polymer-iCOF) that, despite showing good surface contact, has lower selectivity for ion transport; (c) shows the iCOF-poly(ionic liquid) composite material of the present disclosure, showing fast Lit conduction and high selectivity for Li⁺; (d) shows the chemical structure of TpPa—SO₃Li COF used in the embodiments of the present disclosure; (e) shows the chemical structure of p(BVIm-TFSI) used in the embodiments of the present disclosure.

FIG. 2 shows the characterization results of TpPa—SO₃Li-p(BVIm-TFSI) composite material, where (a) is a photo of the composite material; (b) is a scanning electron microscope (SEM) image of the composite material; (c) shows the crystallization of TpPa—SO₃Li-p(BVIm-TFSI) (iCOF content of 20 wt %), TpPa—SO₃H and TpPa—SO₃Li obtained by test using powder X-ray diffraction method; (d) shows the thermal stability of pure p(BVIm-TFSI), TpPa—SO₃Li-p(BVIm-TFSI) composite material and TpPa—SO₃Li iCOF obtained by test using thermogravimetric analysis method; (e) shows the nitrogen adsorption isotherm measured at 77 K for TpPa—SO₃Li iCOF; (f) shows the viscosity of p(BVIm-TFSI) as a function of concentration.

FIG. 3 shows the Lit ion conductivity and lithium ion transport number t_{Li}_{⁺} of TpPa—SO₃Li-p(BVIm-TFSI) composite SSE, where (a) shows the ionic conductivity of TpPa—SO₃Li-p(BVIm-TFSI) composite solid-state electrolytes with different iCOF contents at room temperature (11.0 wt % iCOF, 12.9 wt % iCOF, 15.6 wt % iCOF, 27.0 wt % iCOF, and 42.6 wt % iCOF); (b) shows the Nyquist plot of electrochemical impedance spectroscopy (EIS) system measurements of TpPa—SO₃Li-p(BVIm-TFSI) at different temperatures (iCOF content of 15.6 wt %); (c) shows the chronoamperometry curve of a Li—Li symmetric cell, and the inset is the Nyquist plot of EIS system measurements before and after polarization; (d) shows the comparison of Li⁺ conductivity and t_{Li}_{⁺} of composite SSE prepared with different iCOFs and composite SSE prepared without plasticizers. The composite SSE used for control is specifically, Ref. 16: TpPa—SO₃Li at room temperature^{[}16], Ref. 28: DMA@LiTFSI-mediated COF at room temperature^{[}28], Ref. 29: PEO@TpPa—SO3Li at 60°^{[29]}, Ref. 30: Li-CON-TFSI COF at 30° C.^{[}30], Ref. 31: PVDF/H-COF-1@10 at room temperature^{[}31], Ref. 32: PEG-Li⁺@EB-COF-ClO₄ at 30°^{[32]}, Ref. 33: Im-COF-TFSI@Li at 30°^{[33]}, Ref. 34: dCOF-ImTFSI-60@Li at 30° C.^{[}34], Ref. 17: LiCON-3 at room temperature^{[}17].

FIG. 4 shows the electrochemical performance of TpPa—SO₃Li-p(BVIm-TFSI) SSE in the embodiment of the present disclosure, where (a) shows electrochemical window of TpPa—SO₃Li-p(BVIm-TFSI) SSE, the inset is the local magnified area; (b) shows the cycling capability of Li|SSE|Li symmetrical button battery at room temperature; (c) shows the charge and discharge curve of lithium |SSE| lithium cobalt oxide full button battery at a rate of 0.2 C at room temperature; (d) shows the capacity retention capability and Coulombic efficiency of the lithium |SSE| lithium cobalt oxide full battery during the cycle charge and discharge test.

### DETAILED DESCRIPTION OF EMBODIMENTS

### Definitions

The “ionic covalent organic framework” mentioned in the present disclosure is an ionic covalent organic framework, which is composed of organic molecular backbones and inorganic cations connected by covalent bonds. The “ionic covalent organic framework” in the present disclosure can be expressed as iCOF, and the two can be used interchangeably.

The “poly(ionic liquid)” (PIL) mentioned in the present disclosure is an ionic liquid polymer, which is a type of polymer containing ionic liquid monomers in its repeating units. PIL can be prepared by direct polymerization of ionic liquid monomers or by combining ionic liquid monomers with other monomers for block polymerization. PIL can also be obtained by modifying existing polymers using ionic liquid monomers. According to the different charges of the ions on the backbone, the ionic liquid can be divided into polyanionic liquids, polycationic liquids and polyamphophilic ionic liquids. The cationic groups in the polycationic ionic liquid framework can be: imidazole cations, pyridine cations, quaternary ammonium cations, quaternary phosphonium cations, pyrrole cations, guanidine cations, etc.

In the present disclosure, where a composition is described as having, including, or comprising a particular component, or where a process/method is described as having, including, or comprising a particular process step, it is also contemplated that the composition taught herein may also consists essentially of or consists of listed components, and the processes/methods taught herein may also consists essentially of or consists of listed process steps.

When the expression “about” is used before a numerical value, the present disclosure also includes the specific numerical value itself, unless otherwise specifically stated. As used herein, the expression “about” refers to a range of ±10%, ±7%, ±5%, ±3%, ±2%, ±1% or ±0% of the specified value unless otherwise specifically stated.

In the present disclosure, the expression “optional(ly)” refers to two embodiments in which the features defined by the term (such as components, steps, etc.) may or may not exist.

The advantages and features of the present disclosure will become more apparent from the following optimal embodiments and illustrative examples. The scope of the disclosure is not limited to any specific embodiments described herein.

Provided herein is a composite solid-state electrolyte, comprising: a cationic poly(ionic liquid); and an ionic covalent organic framework (TpPa—SO₃Li) comprising a repeating unit of Formula I:

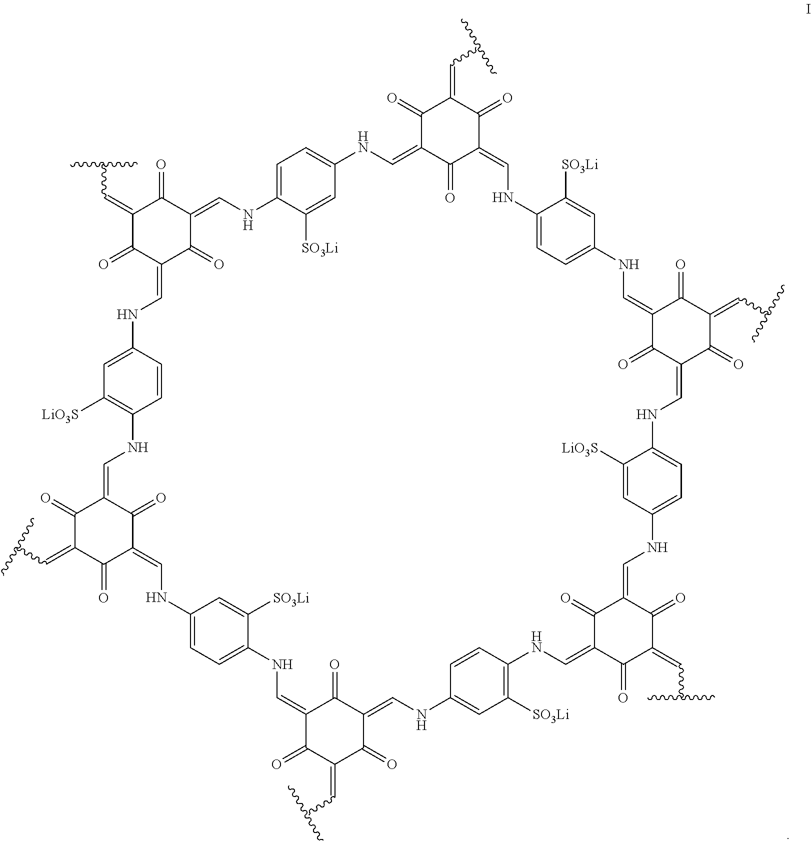

The cationic poly(ionic liquid) is not particularly limited and the present disclosure contemplates any type of cationic poly(ionic liquid) known to those skilled in the art. In certain embodiments, the cationic poly(ionic liquid) comprises a repeating unit of Formula II:

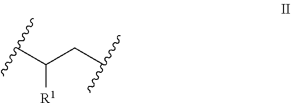

wherein R¹ is selected from the group consisting of:

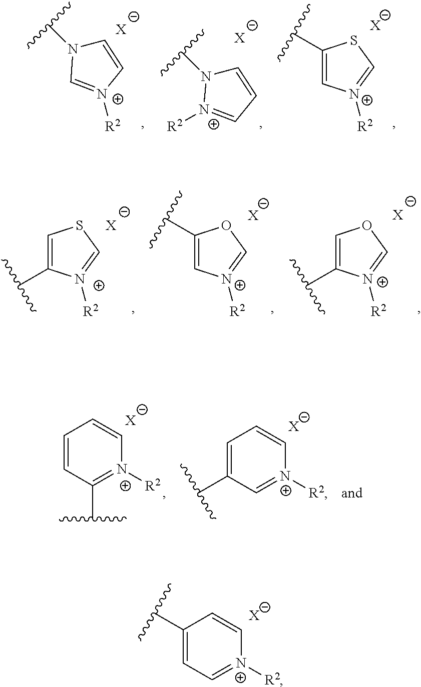

wherein R² is C₁-C₆ alkyl, C₂-C₆ alkyl, C₃-C₆ alkyl, C₃-C₅ alkyl, C₄-C₆ alkyl, C₅-C₆ alkyl, C₁-C₅ alkyl, C₁-C₄ alkyl, C₁-C₃ alkyl, or C₁-C₂ alkyl; and X⁻ is Cl⁻, Br⁻, I⁻, NO₃⁻, BF₄⁻, BCl₄⁻, ClO₄⁻, PF₆⁻, CF₃SO₃⁻, CF₃CO₂⁻, AsF₆⁻, SbF₆⁻, dicyanamide, tetracyanoborate, bis(trifluoromethanesulfonyl)imide, bis(fluorosulfonyl)imide, or (fluorosulfonyl)(trifluoromethylsulfonyl)imide.

In certain embodiments, R¹ is:

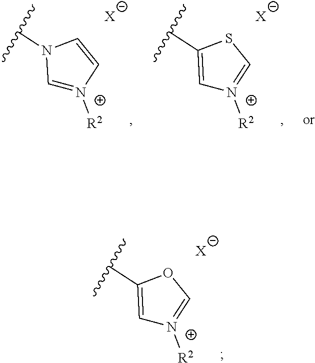

R² is C₁-C₆ alkyl, C₂-C₆ alkyl, C₃-C₆ alkyl, C₃-C₅ alkyl; and X⁻ is as defined herein.

In certain embodiments, the cationic poly(ionic liquid) comprises a repeating unit of Formula III:

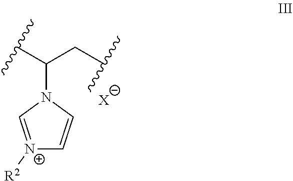

wherein R² is C₁-C₆ alkyl, C₂-C₆ alkyl, C₃-C₆ alkyl, C₃-C₅ alkyl; and X⁻ is as defined herein. In certain embodiments, the cationic poly(ionic liquid) comprises a repeating unit of Formula III, wherein R² is n-butyl; and X⁻ is bis(trifluoromethanesulfonyl)imide.

The viscosity of the cationic poly(ionic liquid) can range from 4 to 10 dL/g, 5 to 9 dL/g, 6 to 8 dL/g, 7 to 8 dL/g, or 7 to 7.5 dL/g,. In certain embodiments, the viscosity of the cationic poly(ionic liquid) is about 7.31 dL/g.

In certain embodiments, TpPa—SO₃Li accounts for 10⁻⁵⁰ wt % of the total weight of the composite solid-state electrolyte. For example, TpPa—SO₃Li accounts for 5 wt %, 10 wt %, 15 wt %, 20 wt %, 25 wt %, 30 wt %, 35 wt %, 40 wt %, or 50 wt % of the total weight of the composite solid-state electrolyte, including a range between the above content values. In certain embodiments, the composite solid-state electrolyte comprises the TpPa—SO₃Li at 10-50 wt %, 10⁻⁴⁰ wt %, 11-42.6 wt %, 10⁻³⁵ wt %, 10⁻³⁰ wt %, 10⁻²⁵ wt %, 11-27 wt %, 10⁻²⁰ wt %, 11-15.6 wt %, 11-12.9 wt %, 11-16 wt %, 11-17 wt %, 11-18 wt %, 11-19 wt %, 11-20 wt %, 11-21 wt %, 11-22 wt %, 11-23 wt %, 11-24 wt %, 11-25 wt %, 11-26 wt %, 11-27 wt %, 15-20 wt %, or about 15.6 wt % of the total weight of the composite solid-state electrolyte.

TpPa—SO₃Li and the the cationic poly(ionic liquid) can be present in the solid-state electrolyte in a mass ratio of 5:95 to 1:1, respectively. In certain embodiments, the TpPa—SO₃Li and the the cationic poly(ionic liquid) are present in the solid-state electrolyte in a mass ratio of 5:95 to 2:3, 5:95 to 3:7, 1:9 to 3:7, 5:95 to 1:4, 1:9 to 1:4, 1:6 to 1:1, 1:6 to 1:2, 1:6 to 1:4, 1:6 to 1:5, 1:5 to 1:4, or 1:5 to 1:2, respectively. In certain embodiments, the concentration of TpPa—SO₃Li in the solid-state electrolyte is 14.2-50 wt %, 14.2-33.3 wt %, 14.2-20 wt %, 16.7-20 wt %, or 14.2-16.7 wt %.

In certain embodiments, the composite solid-state electrolyte further comprises a litihium salt from an external source. The litihium salt from an external source can be one or more lithium salts selected from the group consisting of LiClO₄, LiBF₄, LiPF₆, LiCF₃SO₃, LiCF₃CO₂, LiAsF₆, LiSbF₆, LiAlCl₄, LiCl, LiBr, LiI, lithium bisoxalatoborate, lithium oxalyldifluoroborate, lithium dicyanamide, lithium tetracyanoborate, lithium bis(fluorosulfonyl)imide, lithium (fluorosulfonyl)(trifluoromethylsulfonyl)imide, and lithium bis(trifluoromethanesulfonyl)imide. In certain embodiments, the litihium salt from an external source is lithium bis(trifluoromethanesulfonyl)imide.

In certain embodiments, the the composite solid-state electrolyte does not comprise a liquid organic electrolyte and/or a plasticizer. In certain embodiments, the liquid organic electrolyte and/or plasticizer is propylene carbonate, ethylene carbonate, butylene carbonate, dimethyl carbonate (DMC), diethyl carbonate, methyl ethyl carbonate (MEC), fluoroethylene carbonate (FEC), γ-butyrolactone, methyl formate, methyl acetate, 1,2-dimethoxyethane, tetrahydrofuran, 2-methyltetrahydrofuran, dimethyl sulfoxide, 1,3-dioxolane, formamide, dimethylformamide, dioxane, acetonitrile, nitromethane, ethyl monoglyme, phosphoric triesters, trimethoxymethane, dioxolane derivatives, sulfolane, 3-methyl-2-oxazolidinone, propylene carbonate derivatives, tetrahydrofuran derivatives, ethyl ether, 1,3-propanesultone, N-methyl acetamide, acetonitrile, acetals, ketals, sulfones, sulfolanes, aliphatic ethers, cyclic ethers, glymes, polyethers, phosphate esters, siloxanes, dioxolanes, or N-alkylpyrrolidones.

The present disclosure also provides a method of preparing the solid-state electrolyte, the method comprising: combining TpPa—SO₃Li and the cationic poly(ionic liquid) thereby forming the solid-state electrolyte.

In certain embodiments, the step of combining TpPa—SO₃Li and the cationic poly(ionic liquid) is conducted in a solvent in order to improve intermingingling of the two components.

The selection of the solvent is not particularly limited and can be any solvent in which the reagents are least partially soluble. Exemplary solvents include, but are not limited to, propylene carbonate, ethylene carbonate, butylene carbonate, dimethyl carbonate, diethyl carbonate, methyl ethyl carbonate, γ-butyrolactone, methyl formate, methyl acetate, 1,2-dimethoxyethane, tetrahydrofuran, 2-methyltetrahydrofuran, dimethyl sulfoxide, 1,3-dioxolane, dimethylformamide, dioxane, acetonitrile, nitromethane, and ethyl monoglyme. In certain embodiments, the solvent comprises dimethoxyethane and acetonitrile.

In embodiments in which the TpPa—SO₃Li and the cationic poly(ionic liquid) are combined in a solvent, the solvent can be removed after the two components have been combined using any known method in the art, e.g., as by application of heat and/or exposing the electrocatalyst to reduced pressure. In certain embodiments, the solvent is removed by vacuum drying, air-drying, sun drying, spray drying, infrared radiation drying, microwave drying, convection drying, warm forced air, freeze-drying, and combinations thereof.

TpPa—SO₃Li can be prepared using any method known to those skilled in art. In certain embodiments, TpPa—SO₃Li is prepared by combining 2,5-diaminobenzenesulfonate with 2,4,6-trihydroxybenzene-1,3,5-tricarbaldehyde thereby forming TpPa—SO₃Li.

Also provided herein is a lithium battery comprising: an anode, a cathode, and the composite solid-state electrolyte described herein disposed between the anode and the cathode.

The cathode can comprise any suitable cathode active materials including, but not limited to, lithium transition metal oxides. The lithium transition metal oxide can include elements in addition to lithium, one or more transition metals and oxygen or can consist of lithium, one or more transition metals and oxygen. In instances where the lithium transition metal oxide includes cobalt as a transition metal, the lithium transition metal oxide can include more than one transition metal. In some instances, the lithium transition metal oxide excludes cobalt. The transition metal in the lithium transition metal oxide can include or consist of one or more elements selected from the group consisting of Li, Al, Mg, Ti, B, Ga, Si, Mn, Zn, Mo, Nb, V, Ag, Ni, and Co. Suitable lithium transition metal oxides include, but are not limited to, LiₓVO_{y}, LiCoO₂, LiNiO₂, LiNi_{1-x′}Co_{y′}Me_{z′}O₂, LiMn_{0.5}Ni_{0.5}O₂, LiMn_{1/3}Co_{1/3}Ni_{1/3}O₂, LiFeO₂, Li z Myy0 4, wherein Me is one or more transition metals selected from Li, Al, Mg, Ti, B. Ga, Si, Mn, Zn, Mo, Nb, V, Ag and combinations thereof and M is one or more transition metals such as Mn, Ti, Ni, Co, Cu, Mg, Zn, V, and combinations thereof. In some instances, 0<x<1 before initial charge of the battery and/or 0<y<1 before initial charge of the battery and/or x′ is ≥0 before initial charge of the battery and/or 1−x′+y+z=1 and/or 0.8<Z<1.5 before initial charge of the battery and/or 1.5<yy<2.5 before initial charge of the battery. Additional examples of cathode active materials LiCoO₂, LiNiO₂, LiN₁₋ₓCoyMe_{z}O₂, LiMn_{0.5}Ni_{0.5}O₂, LiMn_{(1/3)}Co_{(1/3)}N_{(1/3)}O₂, and LiNiCo_{y′}Al_{z′}O₂.

The anode can comprise any anode active material known in the art. In certain embodiments, the anode active material comprises a metal selected from Groups IA, IIA, IIIB and IVB of the Periodic Table of the Elements and compounds capable of forming intermetallic compounds and allows with metals selected from Groups IA, IIA, IIIB and IVB of the Periodic Table of the Elements. Examples of these anode active materials include lithium, sodium, potassium and their alloys and compounds capable of forming intermetallic compounds and alloys with lithium, sodium, potassium. Examples of suitable alloys include, but are not limited to, Li—Si, Li—Al, Li—B, Li—Si—B. Examples of suitable intermetallic compounds include, but are not limited to, intermetallic compounds that include or consist of two or more components selected from the group consisting of Li, Ti, Cu, Sb, Mn, Al, Si, Pb, Sn, In, Bi, Ag, Ba, Ca, Hg, Pd, Pt, Te, Zn and La. Other examples of suitable intermetallic compounds include, but are not limited to, intermetallic compounds that comprise lithium metal and one or more components selected from the group consisting of Ti, Cu, Sb, Mn, Al, Si, Pb, Sn, In, Bi, Ag, Ba, Ca, Hg, Pd, Pt, Te, Zn, and La. Other suitable anode active materials include lithium titanium oxides such as Li₄Ti₅O₁₂, silica alloys, and mixtures of the above anode active materials. The anode active material may be a graphite-based material, such as natural graphite, artificial graphite, coke, and carbon fiber; a compound containing at least one element such as Al, Si, Sn, Ag, Bi, Mg, Zn, In, Ge, Pb, and Ti, which can alloy with lithium, sodium, or potassium; a composite composed of the compound containing at least one element which can alloy with lithium, sodium, or potassium, the graphite-based material, and carbon; or a lithium-containing nitride; and combinations thereof.

The lithium battery can be of any type known in the art. Exemplary batteries include, but are not limited to, coin cell, cylindrical cell (including 18650 cells), pouch cell, and prismatic cell.

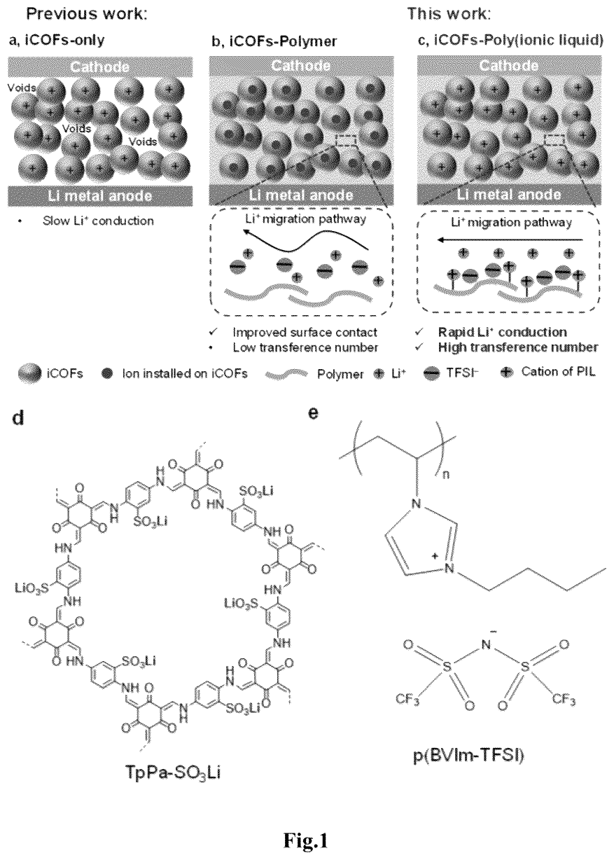

There are only iCOFs in traditional solid-state electrolytes (iCOF SSE), and these structures show higher contact resistance due to the large number of voids between iCOF powders, resulting in low ionic conductivity (FIG. 1a).

Sulfonate COF can be synthesized through Schiff base condensation reaction. TpPa—SO₃ type COF is a sulfonate COF assembled from C3-(1,3,5-triformyl chloride glucitol) and C2-(1,4-phenylenediamine-2-sulfonic acid) symmetric monomers through Schiff base condensation reactions. The anionic sulfonates loaded along the pore framework of the 2D COF and the high porosity (surface area greater than 300 m²g⁻) make it an ideal candidate for cation conduction (such as Li⁺).

As shown in FIG. 1d, TpPa—SO₃Li is a Li⁺ coordination sulfonate COF; Tp and Pa refer to

1,3,5-trifluoromethylchloroglucitol and 1,4-phenylenediamine, respectively^{[16]}. TpPa—SO₃Li has a well-defined pore structure and excellent chemical stability, enabling high ion transport capabilities in energy storage materials/devices, such as in Na-ion batteries^{[20]}, zinc-ion batteries^{[21]} and lithium-ion batteries^{[16]}. However, the relatively low ionic conductivity (for example, Li⁺ conductivity (r.t.) of 2.7×10⁻⁵ Scm⁻¹) limits their practical use in battery devices. In the present disclosure, an example using the TpPa—SO₃Li model system as an iCOF filler is provided.

The inventors found that cationic PIL has the advantage of conducting Li⁺ Unlike anionic PIL, the cationic polymer framework in cationic PIL can coordinate with anionic TFSI⁻. Added Li⁺ from iCOF or an external source (added lithium salt) has lower binding affinity to PIL and iCOF, allowing Li⁺ to migrate freely through the SSE. This unique property of cationic PIL allows better conduction of Li⁺ In addition, imidazole-loaded polyethylene also has many advantages: easy synthesis, diverse anion configurations, easy modification, and excellent chemical and electrochemical stability, and shows good potential in ASSLMB.

The PIL matrix used as an example in the present disclosure is poly 1-butyl-3-vinylimidazolylbistrifluoromethanesulfonimide salt (p(BVIm-TFSI)), which is a cationic PIL with polyethylene as the framework and imidazole as the cation, and has a chemical structure shown in FIG. 1e. In p(BVIm-TFSI), by anchoring bis(trifluoromethanesulfonyl) imine (TFSI-) to the cation site on the polymer framework of PIL, PIL is expected to promote Li⁺ conduction rapidly and selectively (FIG. 1c).

Therefore, embodiments of the present disclosure provide a composite SSE of TpPa—SO₃Li-p(BVIm-TFSI), which is prepared by incorporating poly(ionic liquid) (PIL) into iCOF. In a preferred embodiment, the TpPa—SO3Li-p(BVIm-TFSI) composite SSE can have an excellent ion conductivity up to 1.23×10⁻³ Scm⁻¹ and a lithium ion transport number (t_{Li}_{⁺}) up to 0.82 at room temperature.

Such high ionic conductivity can be explained from two aspects. On one hand, PIL fills the gaps between iCOFs, thereby reducing the contact resistance; On the other hand, after the lithium salt is introduced into the cation p(BVIm-TFSI), a lithium cation-bis(trifluoromethanesulfonyl)imide (TFSI) anion-polycation co-ordination structure would be formed. When this composite SSE is used to assemble lithium|SSE|lithium symmetrical button batteries and lithium|SSE|lithium cobalt oxide full button batteries, this simplified modification achieves good cycle charge and discharge performance and high stability, and provides a new way to manufacture the next generation of high-security ASSLMB.

Specific examples of the present disclosure are described below with reference to the accompanying drawings. It will be understood that various modifications are possible without departing from the scope of the invention as described above. The following examples are provided for illustration only.

### Example 1

### Characterization of the Performance of TpPa—SO3Li-p(BVIm-TFSI) Composite SSE

In this example, TpPa—SO₃Li and p(BVIm-TFSI) were used as raw materials to prepare TpPa—SO₃Li-p(BVIm-TFSI) composite SSE, and the crystallinity, thermal stability, specific surface area or viscosity of the raw materials and the products were characterized.

### Preparation

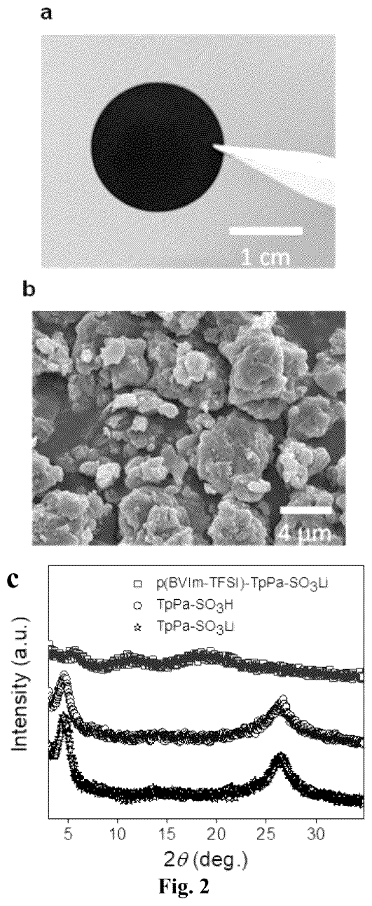

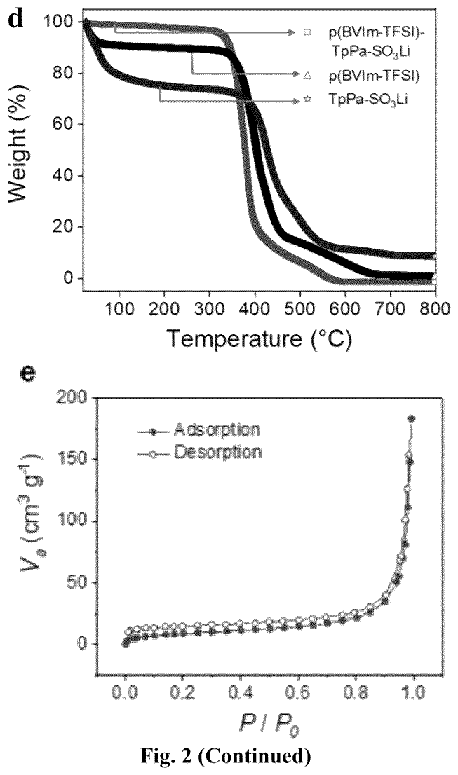

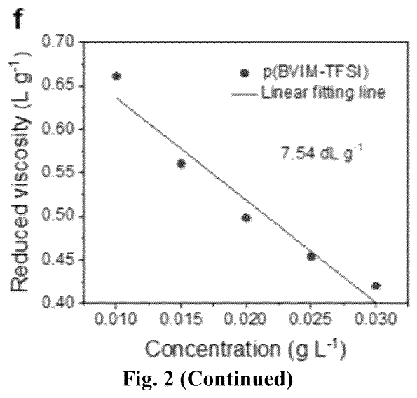

TpPa—SO₃Li and p(BVIm-TFSI) were made into particles in which TpPa—SO₃Li iCOF powder was uniformly dispersed (FIG. 2a). Specifically, p(BVIm-TFSI) was first dissolved in the solvent to obtain a solution, and then TpPa—SO₃Li was immersed in the mixture, which ensured that p(BVIm-TFSI) completely filled within TpPa—SO₃Li iCOFs (FIG. 2b).

First, 80 mg of p(BVIm-TFSI) and 28 mg of LiTFSI were dissolved in 2 ml of ultra-dry acetonitrile and then 20 mg of TpPa—SO₃Li iCOF powder was evenly immersed in the solution, which was left in the glove box overnight. The acetonitrile was then removed in a vacuum oven at 100° C. to completely remove residual acetonitrile solvent. Following the same procedure, different samples of TpPa—SO₃Li/p(BVIm) with iCOF content (42.6 wt %, 27.0 wt %, 15.6 wt %, 12.9 wt % and 11.0 wt % based on the total weight of TpPa—SO₃Li, p(BVIm-TFSI), and LiTFSI using a fixed ratio of p(BVIm-TFSI) to LiTFSI of 1:0.35) SSE were prepared.

Under a pressure of 1 GPa, a certain amount of TpPa—SO₃Li/p(BVIm-TFSI) powder was molded in a capsule shaped mold having a diameter of 14 mm to prepare TpPa—SO₃Li/p(BVIm-TFSI) composite SSE. The average size of the TpPa—SO₃Li/p(BVIm-TFSI) particles in the powder was approximately 400-625 μm.

### Crystallinity

Powder X-ray diffraction (PXRD) using an PANalytical X-ray 5 Diffractometer, Model X'pert Pro was used to charaxterize the crystallinity of the three iCOFs. The test conditions utilized a scanning rate of 2° per minute and scanning range of 3° to 35°. The iCOF of TpPa—SO₃ H and TpPa—SO₃Li obtained via Li⁺ exchange show higher crystallinity, which leads to high transport effiency of lithium ion, high ionic conductivity of composite SSE samples, and lithium ions. This can be seen from two characteristic peaks 4.6° and 26.7° corresponding to the two-dimensional layered structure and the 7C-7C stacking interactions between layers. For the TpPa—SO₃Li-p(BVIm-TFSI) composite SSE sample with an iCOF content of 20 wt %, the characteristic peaks were reduced due to the dispersion of light-matter interaction by the polymer matrix.

### Thermal Stability

Thermal stability is very important for solid-state electrolytes used in ASSLMB. Thermal resistance capability is very important for SSE components in ASSLMB with high-security. High thermal stability means that the intact structure can still be maintained under heating conditions, which is crucial for the conduction of Li⁺ and high safety during charge and discharge. However, the thermal stability of unmodified TpPa—SO₃Li iCOF is low, which needs improvement for SSE materials with high-security.

PIL has low volatility and excellent thermal stability. TpPa—SO₃Li-p(BVIm-TFSI) composite SSE was formed by adding p(BVIm-TFSI) PIL to TpPa—SO₃Li iCOF, and the resulting composite SSE material had thermal stability greatly improved compared with unmodified TpPa—SO₃Li iCOF.

As shown in FIG. 2d, thermogravimetric analysis using a Discovery 25 TGS-5500 (TA) was used to determine the thermal weight loss of TpPa—SO₃Li iCOF, p(BVIm-TFSI) and TpPa—SO₃Li-p(BVIm-TFSI) composite SSE. The tests were conducted in a nitrogen atmosphere in a temperature range from 30-800° C. with a heating rate of 10° C./minute. In the temperature range below about 400° C., the weight retention percentage of TpPa—SO₃Li-p(BVIm-TFSI) composite SSE was about 90 wt % or more than 90 wt %, which is significantly higher than unmodified TpPa—SO₃Li iCOF which had weight retention percentage less than 80 wt %.

Specific Surface Area of iCOF and Viscosity of poly(ionic Liquid)

The specific surface area of TpPa—SO₃Li iCOF was determind using a BELSORP, Model Mini X, MitrotracBel, Corp. instrument and the Brunauer-Emmett-Teller (BET) method at 77K under a nitrogen atmosphere. Test results inidicated that the TpPa—SO₃Li iCOF had a specific surface area of 33 m² g⁻¹. After thorough cleaning of the TpPa—SO₃Li iCOF power this value can be increased to 250 m² g⁻¹ (FIG. 2e). The larger the specific surface area of the TpPa—SO₃Li iCOF, the greater the porosity of the TpPa—SO₃Li iCOF, and more pores it has, which is conducive to the transmission of lithium ions.

The viscosity of p(BVIm-TFSI) was measured using a combination of a Schott Viscometry System (AVS 370, 15 Germany) instrument and Ubbelohde viscometer at a temperature of 25° C. The rest results showed that the viscosity of p(BVIm-TFSI) was as high as 7.54 dLg⁻¹, indicating that this PIL had a large molecular weight (FIG. 2f). This shows that p(BVIm-TFSI) has excellent film-forming properties, giving the SSE excellent mechanical properties.

### Example 2

### Effect of iCOF Content on Li⁺ Ion Conductivity

After comprehensive characterization of iCO and PIL, composite SSE samples containing different proportions of iCOF were prepared in this example. The effect of electrochemical impedance spectroscopy (EIS) iCOF content on the ionic conductivity of composite SSE was used to obtain more preferred conductivity and transport number.

The conductivity and transport number in this example were obtained using an Autolab PGSTAT204 electrochemical workstation at a test frequency range of 1 MHz to 1 Hz with an amplitude of 10 mV. The ionic conductivity was calculated using the following equation:

$$σ = \frac{L}{R * A} ( S / cm )$$

where L is the thickness of the SSE, R is the resistance obtained by electrochemical impedance spectroscopy (EIS), and A is the actual contact area between the electrolyte and the electrode.

The migration number of lithium ions is calculated by the following equation:

$${t}_{L {i}^{+}} = \frac{{I}_{s} * ( ΔV - {I}_{0} * {R}_{0} )}{{I}_{0} * ( ΔV - {I}_{S} * {R}_{S} )}$$

I₀ and Iₛ are respectively the initial current and steady-state current during polarization test. During polarization testing, the applied voltage is 10 mV. R₀ and R_{S} the interface resistance at the initial and steady state of the interface, Interfacial resistance was determined by electrochemical impedance spectroscopy (EIS).

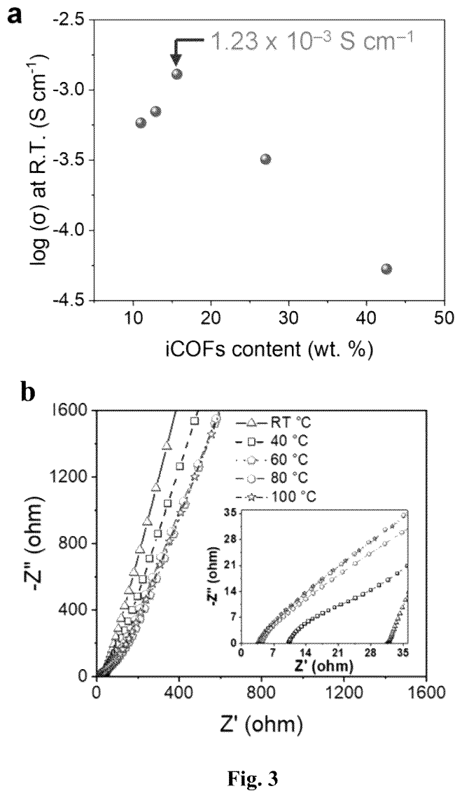

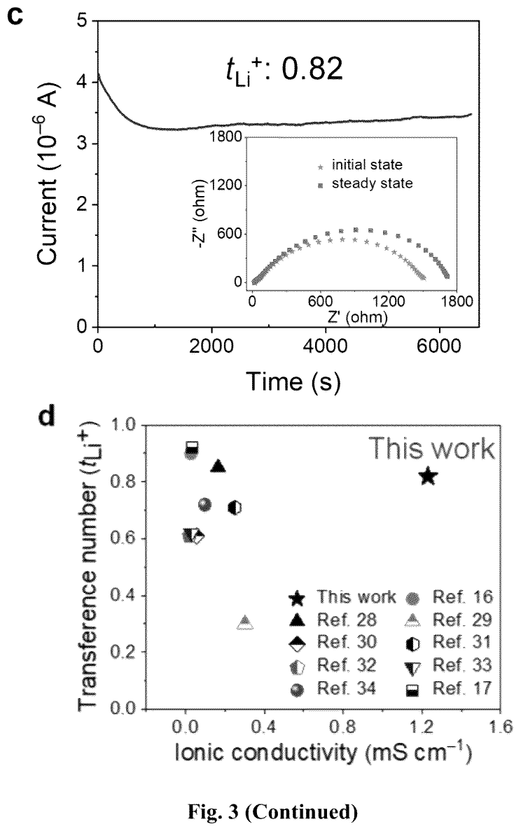

As shown in FIG. 3a, in the composite SSE, the TpPa—SO₃Li iCOF content in the range of 10⁻⁵⁰ wt % can achieve an ionic conductivity higher than 10^{-4.5} Scm⁻¹. In particular, as the TpPa—SO₃Li iCOF content increased from¹⁰ wt % to 15.6 wt %, the ionic conductivity also increased significantly. When the TpPa—SO₃Li iCOF content was 15.6 wt %, the conductivity of Li⁺ can reach 1.23×10⁻³ Scm⁻¹ . Afterwards, as the TpPa—SO₃Li iCOF content continued to increase, the ionic conductivity decreased due to the increase in free volume in the composite SSE sample.

### Example 3

### Li⁺ Ion Conductivity and Li⁺ Transport Number of Composite SSE

In this example, a composite SSE with TpPa—SO₃Li iCOF content of 15.6 wt % was used to study the effect of the composite of p(BVIm-TFSI) and TpPa—SO₃Li on Li⁺ ion conductivity and Li⁺ transport number.

In order to verify the synergistic effect of p(BVIm-TFSI) and TpPa—SO₃Li in achieving high ionic conductivity, the conductivity of p(BVIm-TFSI) only and p(BVIm-TFSI) with added external lithium salt LiTFSI (i.e., p(BVIm-TFSI)-LiTFSI SSE) was measured in this example. The test samples were prepared in accordance with the following protocol:

Dissolve 1 g of p(BVIm-TFSI) and 0.1 g of LiTFSI in 5 ml of ultra-dry acetonitrile solvent. Pour the mixture into a 50 mm diameter round polytetrafluoroethylene (PTFE) container and place at room temperature. Place in the glove box overnight, then transfer to a vacuum oven at 100° C. for 24 hours to completely remove the acetonitrile solvent. Then p(BVIm-TFSI) SSE was molded into capsules with a diameter of 14 mm for 2 min, and the thickness of each SSE is approximately 400 μm. This protocol was followed using different mass ratios of LiTFSI and p(BVIm-TFSI) (2:10, 3:10, 3.5:10, and 4:10 respetively) to prepare p(BVIm-TFSI) SSE.

All p(BVIm-TFSI)-LiTFSI SSEs showed rather low ionic conductivity at room temperature (the maximum value is only 2×10⁻⁶ Scmg⁻¹). As mentioned above, the TpPa—SO₃Li material only also had a low ionic conductivity (for example, Li⁺ conductivity of 2.7×10⁻⁵ Scm⁻¹ at room temperature). This means that neither p(BVIm-TFSI) nor TpPa—SO₃Li single materials can achieve high electrical conductivity.

As mentioned above, when the TpPa—SO₃Li iCOF content was 15.6 wt %, the conductivity of Li⁺ can reach 1.23×10⁻³ Scm⁻¹. For solvent-free and plasticizer-free solid-state electrolytes (as in Example 1 for sold state electrolytes prepared in Li+), it was possible to achieve Li⁺ with conductivity up to 1.23×10⁻³ Scmg⁻¹ at room temperature, which was an impressive value and proved that the strategy of the present disclosure was effective. The high conductivity of TpPa—SO₃Li-p(BVIm-TFSI) composite solid-state electrolyte is attributed to two aspects. First, PIL fills the voids between iCOFs, thereby reducing contact resistance and improving ionic conductivity. On the other hand, p(BVIm-TFSI) is a cationic PIL with TFSI⁻ as counter ions, so when LiTFSI salt form an external source is introduced, Li⁺-TFSI-PIL⁺ coordination structure is formed. According to the XPS results, each PIL unit is loaded with 1.18 units of TFSI⁻. This coordination structure promotes the conduction of lithium ions, and with the increase of lithium salt content in a certain range, the conductivity also increases. Through the combined effect of these two aspects on ionic conductivity, this TpPa—SO₃Li-p(BVIm-TFSI) SSE can achieve excellent ionic conductivity more than 10⁻³ Scm⁻¹ at room temperature without any plasticizers and/or solvents.

In this example, an Autolab PGSTAT204 with FRA32M mode was used for electorchemical impedance spectropscy (EIS), as shown in the inset of FIG. 3C, the test frequency range was 1 MHz to 1 Hz with an amplitude of 10 mV to obtain the Nyquist plots of TpPa—SO₃Li-p(BVIm-TFSI) composite SSE with a TpPa—SO₃Li iCOF content of 15.6 wt % ns at different temperatures (FIG. 3b). Due to the rapid diffusion of ions in SSE, the resistance decreased with increasing temperature. It was easy to obtain high t_{Li}_{⁺} for SSE of single ion system, so the t_{Li}_{⁺} of the SSE material of TpPa—SO₃Li iCOF can be as high as 0.9 at room temperature. In an example of the present disclosure, since the migrated TFSI participates in ion transport, the composite SSE in this embodiment is not a single ion conductive SSE. Nevertheless, due to the efficient Li⁺ transport of the composite SSE in this example, the t_{Li}_{⁺} of TpPa—SO₃Li-p(BVIm-TFSI) SSE is still as high as 0.82 at room temperature (FIG. 3c).

It is worth noting that the TpPa—SO₃Li-p(BVIm-TFSI) composite SSE material exhibits high ionic conductivity without significantly affecting the t_{Li}_{⁺} value. The Li⁺ conductivity and t_{Li}_{⁺} of iCOF-based SSE and solvent-free and plasticizer-free SSE are compared in FIG. 3d. As shown in FIG. 3d, the TpPa—SO₃Li-p(BVIm-TFSI) composite SSE material sample (containing 15.6 wt % of TpPa—SO₃Li) in the example of the present disclosure has the best comprehensive performance, that is, it shows a high ionic conductivity of 1.23×10⁻³ Scm⁻¹ without significantly affecting the t_{Li}_{⁺} value. In comparison, all other control samples Ref. 16-17 and Ref. 28-34 have conductivities below 1 mScm⁻¹.

Therefore, the TpPa—SO₃Li-p (BVIm-TFSI) composite SSE shows an optimized ionic conductivity at room temperature, which is much larger than the known pure iCOF SSE and the SSE of other iCOF mixtures. To date, the ionic conductivity of 1.23×10⁻³ Scm⁻¹ is the highest value for iCOF-based SSE at room temperature. In some cases, t_{Li}_{⁺} measured for TpPa—SO₃Li-p(BVIm-TFSI) SSE was even slightly higher than the 0.82 measured in this example. Although some SSE may have a slightly higher t_{Li}_{⁺} than 0.82 meausred for this sample (t_{Li}_{⁺} of pure TpPa—SO₃Li was 0.9), its ionic conductivity is much lower than that of TpPa—SO₃Li-p(BVIm-TFSI) SSE. This example demonstrated that TpPa—SO₃Li-p(BVIm-TFSI) SSE shows great potential in the next generation of ASSLMB.

### Example 4

### Electrochemical Window of Composite SSE

This example used a composite SSE with a TpPa—SO₃Li iCOF content of 15.6 wt %, and the electrochemical properties of the composite SSE were further measured and the composite SSE was used to make batteries.

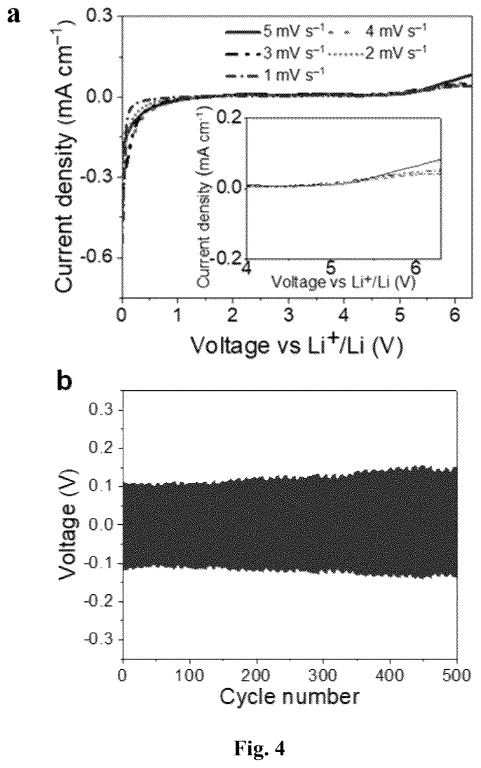

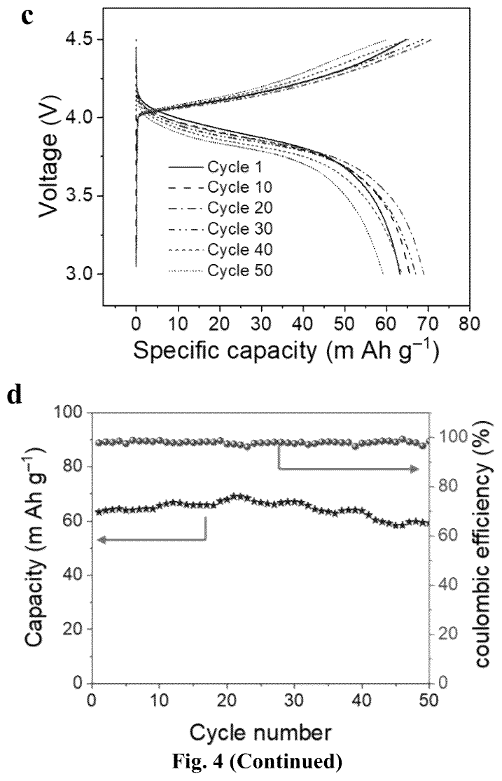

In this example, an Autolab (PGSTAT204 with FRA32M) electrochemical workstation was used to determine the electrochemical window of the electrolyte by learn sweep voltamemetry (LSV). The electrochemical window of the electrolyte is very important for the practical use of batteries, and a wide electrochemical window indicates excellent stability at high operating voltages. As shown in FIG. 4a, the TpPa—SO₃Li-p(BVIm-TFSI) SSE in this example all showed a wide electrochemical window (more thant 5 V) at different scan rates (1 mVs⁻¹s, 2 mVs⁻¹s, 3 mVs⁻¹s, 4 mVs⁻¹s and 5 mVs⁻¹). In comparison, the electrochemical window of conventional carbonate liquid electrolytes is less than 4.2 V^{[35]}. The solid-state electrolyte provided by the present disclosure has a significantly wider electrochemical window and has obvious stability advantages under high operating voltages.

### Example 5

### Specific Capacity and Cycle Stability of Composite SSE

In order to study the performance of TpPa—SO₃Li-p(BVIm-TFSI) solid-state electrolyte in batteries, Li'composite SSEILi symmetric button batteries and Li'composite SSEI LiCoO₂ full button batteries were made using this solid-state electrolyte.

As shown in FIG. 4b, the prepared lithium|composite SSE|lithium symmetric button batteries have good cycle charge and discharge performance at room temperature. The voltage between the two lithium metal electrodes is close to 0 and remains constant after 500 cycles. This shows that TpPa—SO₃Li-p(BVIm-TFSI) can well maintain a high lithium ion transport capacity when used as SSE.

For ASSLBM, specific capacity and cycle stability are the two most critical parameters for battery evaluation. The ASSLBM prepared in this example was lithium composite SSE|lithium cobalt oxide full button batteries, using lithium as the anode, lithium cobalt oxide as the cathode, and using the composite SSE with a TpPa—SO₃Li iCOF content of 15.6 wt % provided by the disclosure. As shown in FIG. 4c, this type of batteries has an acceptable specific capacity of 63 mAhg⁻¹ at 0.2 C. As shown in FIG. 4d, the Coulombic efficiency remains at 100% during the cycle test, and the capacity retention capability is approximately 94% after 50 cycles. The capacity vibration is attributed to electrons hopping in SSE, but this vibration tends to stabilize if more charge-discharge cycles are performed.

The above description of the examples is to facilitate those of ordinary skill in the art to understand and apply the present invention. It is obvious that those skilled in the art can easily make various modifications to these examples and apply the general principles described herein to other examples without inventive efforts. Therefore, the present invention is not limited to the specific examples disclosed herein. Improvements and modifications made by those skilled in the art based on the principles of the present invention without departing from the scope of the present invention should be within the protection scope of the present invention.

### REFERENCES

ADDIN EN.REFLIST 1. Wu, F., J. Maier, and Y. Yu, Guidelines and trends for next-generation rechargeable lithium and lithium-ion batteries. Chem Soc Rev, 2020. 49(5): p. 1569-1614.
2. Randau, S., et al., Benchmarking the performance of all-solid-state lithium batteries. Nature Energy, 2020. 5(3): p. 259-270.
3 Manthiram, A., X. Yu, and S. Wang, Lithium battery chemistries enabled by solid-state electrolytes. Nature Reviews Materials, 2017. 2(4).
4. Kim, K.J., et al., Solid-State Li-Metal Batteries: Challenges and Horizons of Oxide and Sulfide Solid Electrolytes and Their Interfaces. Advanced Energy Materials, 2020. 11(1).
5. Wu, J., et al., Ultrathin, Flexible Polymer Electrolyte for Cost-Effective Fabrication of All-Solid-State Lithium Metal Batteries. Advanced Energy Materials, 2019. 9(46).
6. Ohta, S., et al., Electrochemical performance of an all-solid-state lithium ion battery with garnet-type oxide electrolyte. Journal of Power Sources, 2012. 202: p. 332-335.
7 Kamaya, N., et al., A lithium superionic conductor Nature materials, 2011. 10(9): p. 682-686.
8. Cote, A.P., et al., Porous, crystalline, covalent organic frameworks. science, 2005. 310(5751): p. 1166-1170.
9. Du, Y, et al., Ionic Covalent Organic Frameworks with Spiroborate Linkage. Angew Chem Int Ed Engl, 2016. 55(5): p. 1737-41.
10. Liang, X., et al., Ionic Covalent Organic Frameworks for Energy Devices. Adv Mater, 2021. 33(52): p. e2105647.
11. Yu, F., et al., Ionic covalent organic framework based electrolyte for fast-response ultra-low voltage electrochemical actuators. Nat Commun, 2022. 13(1): p. 390.
12. Tao, S., et al., Hydroxide Anion Transport in Covalent Organic Frameworks. J Am Chem Soc, 2021. 143(24): p. 8970-8975.
13. Zhao, J., et al., Covalent organic framework film protected zinc anode for highly stable rechargeable aqueous zinc-ion batteries. Energy Storage Materials, 2022. 48: p. 82-89.
14. Cao, Y., et al., Ion Selective Covalent Organic Framework Enabling Enhanced Electrochemical Performance of Lithium-Sulfur Batteries. Nano Lett, 2021. 21(7): p. 2997-3006.
15. Zhao, J., et al., In situ interfacial polymerization of lithiophilic COF@PP and POP@PP separators with lower shuttle effect and higher ion transport for high-performance Li-S batteries. Chemical Engineering Journal, 2022. 442.
16. Jeong, K., et al., Solvent-Free, Single Lithium-Ion Conducting Covalent Organic Frameworks. J Am Chem Soc, 2019. 141(14): p. 5880-5885.
17. Li, X., et al., Solution-processable covalent organic framework electrolytes for all-solid-state Li-organic batteries. ACS Energy Letters, 2020. 5(11): p. 3498-3506.
18. Meng, F., et al., Synthesis of Ionic Vinylene-Linked Covalent Organic Frameworks through Quaternization-Activated Knoevenagel Condensation. Angewandte Chemie International Edition, 2021. 60(24): p. 13614-13620.
19. Hu, Y, et al., Crystalline lithium imidazolate covalent organic frameworks with high Li-ion conductivity. Journal ofthe American Chemical Society, 2019. 141(18): p. 7518-7525.
20. Zhang, X., et al., Covalent-organic-frameworks derived N-doped porous carbon materials as anode for superior long-life cycling lithium and sodium ion batteries. Carbon, 2017. 116: p. 686-694.
21. Zhao, J., et al., Covalent organic framework film protected zinc anode for highly stable rechargeable aqueous zinc-ion batteries. Energy Storage Materials, 2022. 48: p. 82-89.
22. Angell, C., C. Liu, and E. Sanchez, Rubbery solid electrolytes with dominant cationic transport and high ambient conductivity. Nature, 1993. 362(6416): p. 137-139.
23. Wang, X., et al., Poly(Ionic Liquid)s-in-Salt Electrolytes with Co-coordination-Assisted Lithium-Ion Transport for Safe Batteries. Joule, 2019. 3(11): p. 2687-2702.
24. Chen, F., et al., Cationic polymer-in-salt electrolytes for fast metal ion conduction and solid-state battery applications. Nature Materials, 2022: p. 1-8.
25. Yuan, J., D. Mecerreyes, and M. Antonietti, Poly (ionic liquid) s: An update. Progress in Polymer Science, 2013. 38(7): p. 1009-1036.
26. Ma, F., et al., Solid polymer electrolyte based on polymerized ionic liquid for high performance all-solid-state lithium-ion batteries. ACS Sustainable Chemistry & Engineering, 2019. 7(5): p. 4675-4683.
27. Qian, W., J. Texter, and F. Yan, Frontiers in poly (ionic liquid) s: syntheses and applications. Chemical Society Reviews, 2017. 46(4): p. 1124-1159.
28. Guo, D., et al., Foldable Solid-State Batteries Enabled by Electrolyte Mediation in Covalent Organic Frameworks. Advanced Materials, 2022: p. 2201410.
29. Yao, Y., et al., Enhanced Electrochemical Performance of Poly (ethylene oxide) Composite Polymer Electrolyte via Incorporating Lithiated Covalent Organic Framework. Transactions of Tianjin University, 2022. 28(1): p. 67-72.
30. Chen, H., et al., Cationic covalent organic framework nanosheets for fast Li-ion conduction. Journal of the American Chemical Society, 2018. 140(3): p. 896-899.
31. Dong, D., et al., Porous covalent organic frameworks for high transference number polymer-based electrolytes. Chemical Communications, 2019. 55(10): p. 1458-1461.
32. Guo, Z., et al., Fast ion transport pathway provided by polyethylene glycol confined in covalent organic frameworks. Journal of the American Chemical Society, 2019. 141(5): p. 1923-1927.
33. Li, Z., et al., Cationic covalent organic framework based all-solid-state electrolytes. Materials Chemistry Frontiers, 2020. 4(4): p. 1164-1173.
34. Li, Z., et al., Defective 2D covalent organic frameworks for postfunctionalization. Advanced Functional Materials, 2020. 30(10): p. 1909267.
35. Park, J.-K., Principles and applications of lithium secondary batteries. 2012: John Wiley & Sons.

What is claimed is:

1. A composite solid-state electrolyte, comprising:
a cationic poly(ionic liquid); and
an ionic covalent organic framework (TpPa—SO₃Li) comprising a repeating unit of Formula I:

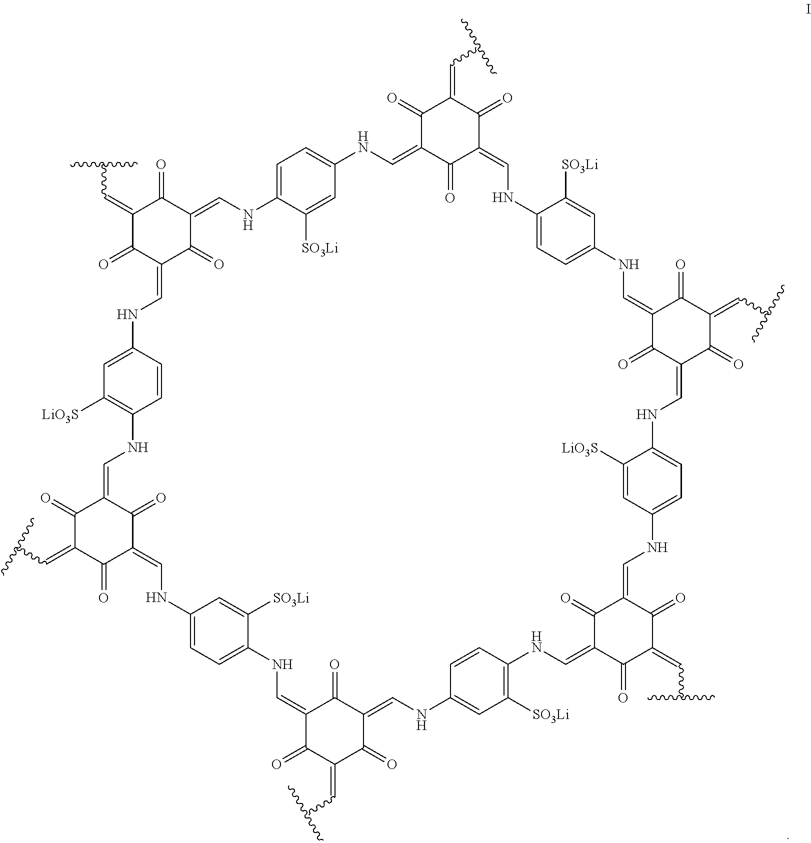

2. The composite solid-state electrolyte according to claim 1, wherein the cationic poly(ionic liquid) comprises a repeating unit of Formula II: 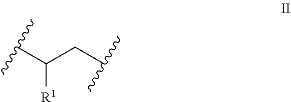
wherein R¹ is selected from the group consisting of: 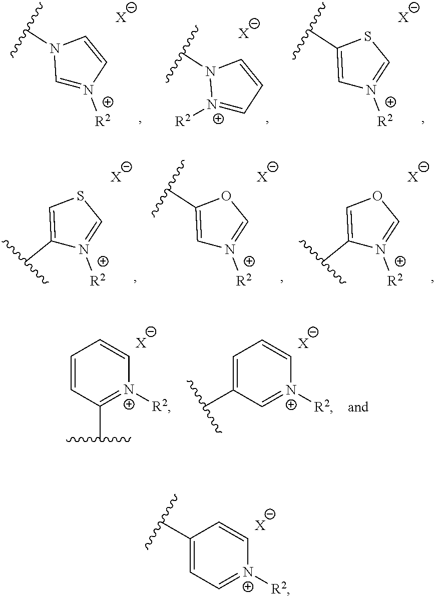
wherein R² is C₁-C₆ alkyl; and X⁻ is an anion.

3. The composite solid-state electrolyte according to claim 2, wherein R¹ is:

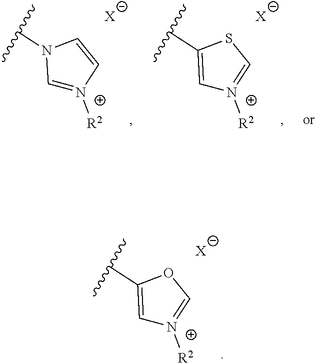

4. The composite solid-state electrolyte according to claim 1, wherein the cationic poly(ionic liquid) comprises a poly(1-(C₃-C₅ alkyl)-3-vinylimidazolylium) salt.

5. The composite solid-state electrolyte according to claim 1, wherein the cationic poly(ionic liquid) comprises a poly(1-butyl-3-vinylimidazolylium) salt.

6. The composite solid-state electrolyte according to claim 1, wherein the cationic poly(ionic liquid) is poly(1-butyl-3-vinylimidazolylium) bis(trifluoromethanesulfonyl)imide salt.

7. The composite solid-state electrolyte according to claim 6, wherein the poly(1-butyl-3-vinylimidazolylium) bis(trifluoromethanesulfonyl)imide salt is combined with a lithium salt from an external source.

8. The composite solid-state electrolyte according to claim 1, wherein TpPa—SO₃Li is prepared according to a method comprising combining 2,5-diaminobenzenesulfonate with 2,4,6-trihydroxybenzene-1,3,5-tricarbaldehyde thereby forming TpPa—SO₃Li.

9. The composite solid-state electrolyte according to claim 1, wherein TpPa—SO₃Li accounts for 10⁻⁵⁰ wt % of the total weight of the composite solid-state electrolyte.

10. The composite solid-state electrolyte according to claim 1, wherein the TpPa—SO₃Li accounts for 10^{-15.6} wt % of the total weight of the composite solid-state electrolyte.

11. The composite solid-state electrolyte according to claim 1, wherein the cationic poly(ionic liquid) is poly(1-butyl-3-vinylimidazolylium) bis(trifluoromethanesulfonyl)imide salt and TpPa—SO₃Li and poly(1-butyl-3-vinylimidazolylium) bis(trifluoromethanesulfonyl)imide salt are present in a mass ratio of 95:5 to 1:1, respectively.

12. The composite solid-state electrolyte according to claim 1, wherein the composite solid-state electrolyte does not comprise an organic solvent or a plasticizer.

13. An all-solid-state lithium metal battery, comprising the composite solid-state electrolyte according to claim 1.

14. The all-solid-state lithium metal battery according to claim 13, wherein the all-solid-state lithium metal battery is selected from a symmetric button battery, a full button battery and a pouch battery.

15. The all-solid-state lithium metal battery according to claim 14, wherein the all-solid-state lithium metal battery is a lithium|composite solid-state electrolyte|lithium symmetric button battery or a lithium|composite solid-state electrolyte|lithium cobalt oxide full button battery.

16. A method for preparing the composite solid-state electrolyte according to claim 1, comprising combining the cationic poly(ionic liquid) and TpPa—SO₃Li thereby forming the composite solid-state electrolyte.
